(19) United States
(12) Patent Application Publication
(10) Pub. No.: US 2011/0153695 A1
(43) Pub. Date: Jun. 23, 2011

(54) METHOD FOR MAKING USB STORAGE OF FILE SYSTEM AND REMOTE CONNECTION, AND SYSTEM THEREOF

(75) Inventors: Kyu-Chang KANG, Daejeon (KR); Jeun-Woo Lee, Daejeon (KR)

(73) Assignee: ELECTRONICS AND TELECOMMUNICATIONS RESEARCH INSTITUTE, Daejeon-city (KR)

(21) Appl. No.: 12/967,599

(22) Filed: Dec. 14, 2010

(30) Foreign Application Priority Data
Dec. 21, 2009 (KR) 10-2009-0128392

(51) Int. Cl. G06F 15/16; G06F 17/30

(52) U.S. Cl. 707/827; 709/227; 707/E17.01

(57) ABSTRACT

Provided are a client computing terminal including: a client user setting unit receiving connection setting information of a host computing terminal to be communicated and file system conversion setting information for converting a predetermined file system into a USB file system from a user, and storing the corresponding information; a USB/IP communication unit setting communication connection with the host computing terminal by using the connection setting information, generating a USB request block (URB) packet, transmitting the URB packet to the host computing terminal, and receiving and analyzing the URB packet from the host computing terminal; and a USB converting unit converting the predetermined file system into the USB storage by using the file system conversion setting information.

This application claims priority to Korean Patent Application No. 10-2009-0128392 filed on Dec. 21, 2009, the entire contents of which is herein incorporated by reference.

### BACKGROUND OF THE INVENTION

1. Field of the Invention

The present invention relates to a method for making a USB storage of a file system and remote connection, and a system thereof. More particularly, the present invention relates to a method for making a USB storage of a file system of a client computing terminal, which is remotely used as the USB storage through remote connection and a system thereof.

2. Description of the Related Art

A universal serial bus (USB), as a type of a universal serial bus developed for standardization of an interface to allow communication between a computer and peripheral devices, has substituted for diversified use of serial and parallel ports.

The USB is used to connect peripheral devices such as a mouse, a keyboard, a PDA, a game pad, a joystick, a scanner, a digital camera, a printer, a modem, a speaker, a personal media player, a flash driver, an external hard disk, and the like with a computer.

The USB defines class codes in order to classify the functions of the peripheral devices and load device drivers on the basis of the classified functions. The class codes allow devices manufactured by different manufacturers, which are compatible with class codes given to a device driver developer to be supported. The class codes include an audio, an image, a printer, a video, a wireless controller, a smart card, a mass storage, and the like.

### SUMMARY OF THE INVENTION

The present invention relates to a mass storage among USB class codes, and it has been made in an effort to provide a method for a user to conveniently use distributed file systems by generating some of predetermined file systems as a USB storage, remotely connecting the generated storage through a network, and connecting the distributed file systems to the USB storage without a distance limit.

An exemplary embodiment of the present invention provides a client computing terminal including: a client user setting unit receiving connection setting information of a host computing terminal to be communicated and file system conversion setting information for converting a predetermined file system into a USB file system from a user, and storing the corresponding information; a USB/IP communication unit setting communication connection with the host computing terminal by using the connection setting information, generating a USB request block (URB) packet, transmitting the URB packet to the host computing terminal, and receiving and analyzing the URB packet from the host computing terminal; and a USB converting unit converting the predetermined file system into the USB storage by using the file system conversion setting information.

In particular, the connection setting information may include IP and port information of the host computing terminal.

The predetermined file system may be an operating system supporting file system supported in an operating system of the client computing terminal or an external file system which is connected or disconnected by the user.

The operating system supporting file system may be any one of FAT, EXT, and NTFS.

The external file system may be a memory stick or an external hard disk.

The client user setting unit may include a control portion setting communication connection with the host computing terminal without any subsequent reinput from the user by using the stored connection setting information.

The control portion may transfer the stored connection setting information to the USB/IP communication unit to set communication connection with the host terminal.

The USB/IP communication unit may include: a communication setting portion setting communication connection with the host computing terminal by using the connection setting information of the host computing terminal received from the client user setting unit; a URB processing portion generating a URB packet to be transmitted to the host computing terminal and analyzing a URB packet received from the host computing terminal when communicating with the host computing terminal; and a URB transmitting/receiving portion transmitting the URB packet generated by the URB processing portion to the host computing terminal and receiving the URB packet from the host computing terminal and transferring the received URB packet to the URB processing portion.

The USB converting unit may include: a file system setting portion receiving the file system conversion setting information from the client user setting unit; and a file converting portion converting the predetermined file system into the USB storage by using the file system conversion setting information received from the file system setting portion.

Another exemplary embodiment of the present invention provides a host computing terminal including: a host user setting unit receiving and storing connection setting information of a client computing terminal to be communicated from a user and storing the received connection setting information, and receiving and storing information transmitted when a USB storage is set in the client computing terminal; and a USB/IP communication unit setting communication connection with the client computing terminal by using the connection setting information, generating a USB request block (URB) packet and transmitting the generated URB packet to the client computing terminal, and receiving and analyzing the URB packet from the client computing terminal.

In particular, the connection setting information may include IP and port information of the client computing terminal.

The host user setting unit may include a control portion setting communication connection with the client computing terminal without any subsequent reinput form the user by using the stored connection setting information.

The host computing terminal may further include: a communication setting portion receiving information from the host user setting unit and setting communication connection with the client computing terminal on the basis of the received information; a URB processing portion generating the USB request block (URB) packet to be transmitted to the client computing terminal and analyzing the URB packet received from the client computing terminal; and a URB transmitting/receiving portion transmitting the URB packet generated by the URB processing portion to the client computing terminal and receiving the URB packet from the client computing terminal and transferring the received URB packet to the URB processing portion.

Yet another exemplary embodiment of the present invention provides a method for making a USB storage of a file system and remote connection, the method including: receiving, by a client computing terminal, connection setting information of a host computing terminal and file system conversion setting information for converting a predetermined file system into a USB file system from a user and storing the corresponding information; setting communication connection with the host computing terminal on the basis of the connection setting information of the host computing terminal; and generating the USB file system in the predetermined file system on the basis of the file system conversion setting information.

In particular, the method may further include generating a USB request block (URB) packet and transmitting the generated URB packet to the host computing terminal and receiving the URB packet from the host computing terminal and analyzing the received URB packet.

The connection setting information may include IP and port information of the host computing terminal.

The predetermined file system may be an operating system supporting file system supported in an operating system of the client computing terminal or an external file system which is connected or disconnected by the user.

The operating system supporting file system may be any one of FAT, EXT, and NTFS.

The external file system may be a memory stick or an external hard disk.

The method may further include setting communication connection with the host computing terminal without any subsequent reinput from the user b using the stored connection setting information.

According to the exemplary embodiments of the present invention, the following effects can be achieved.

According to the exemplary embodiments of the present invention, it is possible to make a USB storage of distributed file systems of a computing device owned or managed by a user to thereby customize the distributed file systems into user's desired size and file system.

Further, in the case where the distributed file systems can be connected to each other through a network, it is possible to use the USB storage served file systems like a local USB storage without a distance limit through the network.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a diagram for describing components of a system according to an exemplary embodiment of the present invention;

FIG. 2 is a diagram for describing components of a host computing terminal and a client computing terminal shown in FIG. 1;

FIG. 3 is a diagram for describing in detail the components of the hosting computing terminal shown in FIG. 2;

FIG. 4 is a diagram for describing in detail the components of the client computing terminal shown in FIG. 2;

FIGS. 5 and 6 are diagrams for describing a method for making a USB storage of a file system of a client computing terminal and remote connection;

FIG. 7 is a diagram for describing a remote connection method in the host computing terminal; and

FIG. 8 illustrates a procedure of generating a USB file system to be used as a storage in a USB converting unit of the client computing terminal.

### DETAILED DESCRIPTION OF THE EMBODIMENTS

The present invention will be described below with reference to the accompanying drawings. Herein, the detailed description of a known function and configuration that may make the purpose of the present invention unnecessarily ambiguous in describing the spirit of the present invention will be omitted. Exemplary embodiments of the present invention are provided so that those skilled in the art may more completely understand the present invention. Accordingly, the shape, the size, etc., of elements in the figures may be exaggerated for explicit comprehension.

The present invention relates to an apparatus and a method for making a USB storage of a file system and remote connection, and more particularly, to an apparatus and a method for making a USB storage of a computer file system, which is remotely used as the USB storage through remote connection.

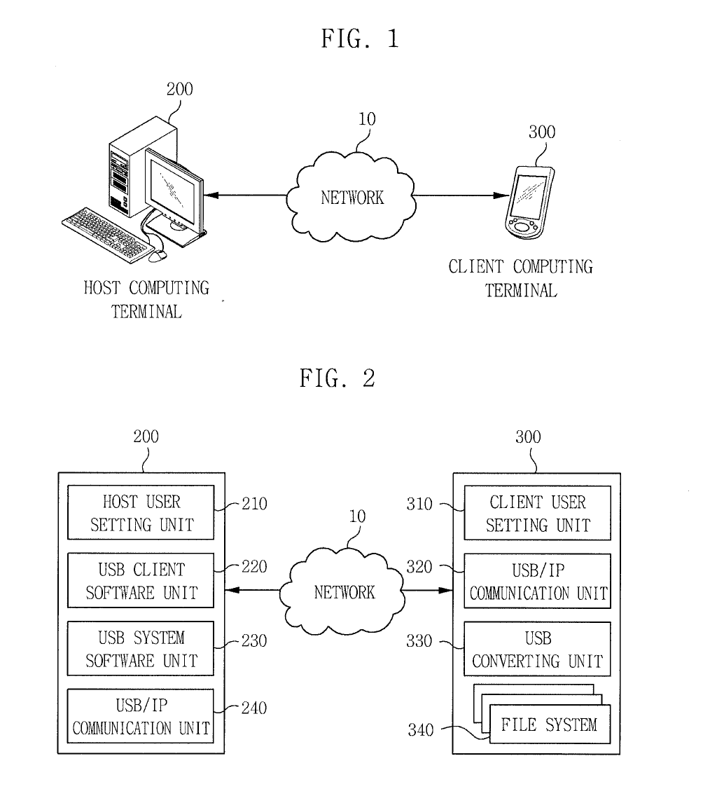

FIG. 1 is a diagram for describing components of a system according to an exemplary embodiment of the present invention.

Referring to FIG. 1, the system according to the exemplary embodiment of the present invention includes a host computing terminal 200 and client computing terminals 300 that are connected with the host computing terminal 200 through a network(10) such as an Internet network and are distributively positioned. The host computing terminal 200 and the client terminal 300 transmit and receive data for making a USB storage of a file system and remote connection therebetween to and from each other through the network(10).

A user may conveniently use distributed file systems by generating some of file systems of a predetermined client computing terminal 300 as a USB storage through the host computing terminal 200, remotely connecting the generated storage through the network, and connecting the file systems of the distributed client computing terminals 300 to the USB storage without a distance limit.

According to the exemplary embodiment of the present invention, it is possible to make a USB storage of distributed file systems of the computing devices (the client computing terminals of FIG. 1) owned or managed by a user to customize the distributed file systems into user's desired size and file system. Any terminal having a computing function and the file system may be used as the client terminal according to the exemplary embodiment of the present invention. For example, a PC, a PDA, a smart phone, a cellular phone, a laptop, a laptop, and the like may be used as the client terminal.

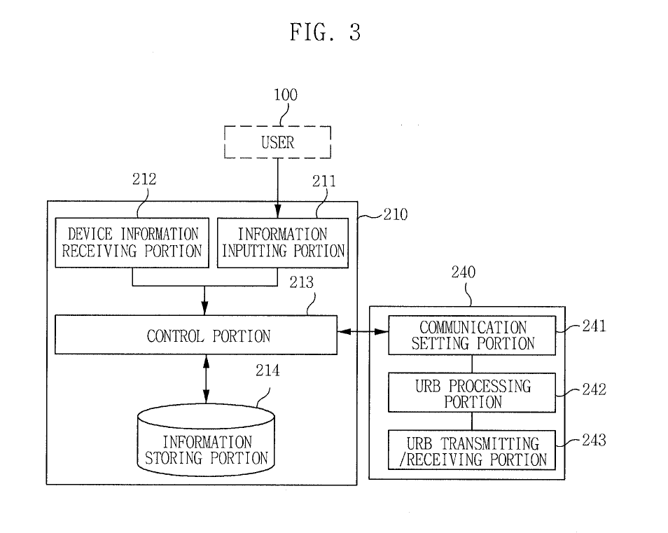

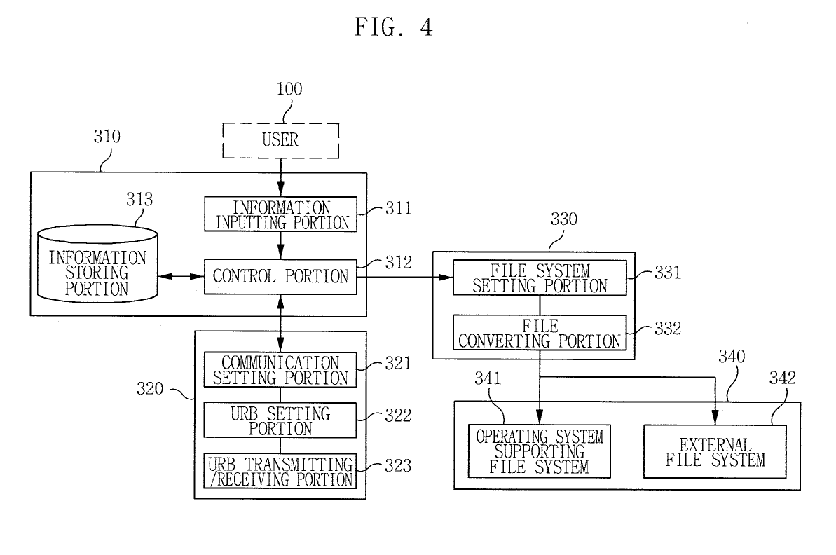

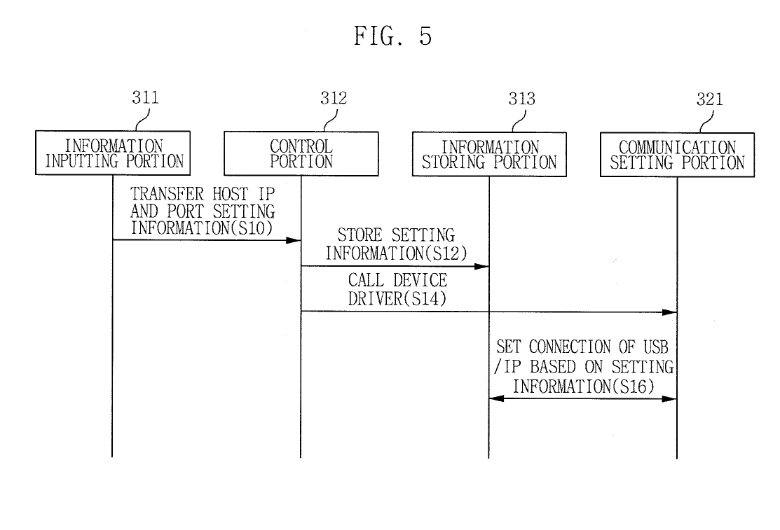

FIG. 2 is a diagram for describing components of the host computing terminal 200 and the client computing terminal 300 shown in FIG. 1. FIG. 3 is a diagram for describing in detail the components of the host computing terminal 200 shown in FIG. 2 and FIG. 4 is a diagram for describing in detail the components of the client computing terminal 300 shown in FIG. 2.

Referring to FIG. 2, first, the host computing terminal 200 according to the exemplary embodiment of the present invention includes a host user setting unit 210, a USB client software unit 220, a USB system software unit 230, and a USB/IP communication unit 240. In addition, the client computing terminal 300 according to the exemplary embodiment of the present invention includes a client user setting unit 310, a USB/IP communication unit 320, a USB converting unit 330, and a file system 340.

First, referring to FIG. 3, each of the components of the host computing terminal 200 will be described in more detail.

The USB client software unit 220 and the USB system software unit 230 are generally installed in the host computing terminal (alternatively, device) in order to use a USB device. Since they are known components, a description thereof will be omitted in order to clearly describe the spirit of the present invention.

The host user setting unit 210 includes an information inputting portion 211, a device information receiving portion 212, a user control portion 213, and an information storing portion 214.

First, the information inputting portion 211 receives connection setting information (i.e., IP and port information of the client computing terminal) on the client computing terminal 300 to be used as the USB storage from a user 100.

The device information receiving portion 212 receives device connection information transmitted when the USB storage is set up in the client computing terminal 300.

The control portion 213 stores the information obtained through the information inputting portion 211 and the device information receiving portion 212 in the information storing portion 214 in order to automatically use the corresponding information at the time of connecting the client computing terminal 300 afterwards.

Further, in the case where the control portion 213 receives the device connection information from the device information receiving portion 212 or receives a specific input by the user from the information inputting portion 211, it transfers the information to the communication setting portion 241 of the USB/IP communication unit 240 to set communication connection with the client computing terminal 300.

The USB/IP communication unit 240 includes a communication setting portion 241, a URB processing portion 242, and a URB transmitting/receiving portion 243.

The communication setting portion 241 receives the information from the control portion 213 of the host user setting unit 210 and sets communication connection with the client computing terminal 300 on the basis of the received information.

The URB processing portion 242 generates a USB request block (URB) packet to be transmitted to the client computing terminal 300 and analyzes a URB packet received from the client computing terminal 300.

The URB transmitting/receiving portion 243 transmits the URB packet generated by the URB processing portion 242 to the client computing terminal 300 and receives the URB packet from the client computing terminal 300 and transfers it to the URB processing portion 242.

Next, referring to FIG. 4, each of the components of the client computing terminal 300 will be described in more detail.

First, the client user setting unit 310 includes an information inputting portion 311, a control portion 312, and an information storing portion 313.

The information inputting portion 311 receives IP and port information (connection setting information) of a host computing terminal 200 which the information inputting portion 311 intends to communicate and setting information (file system conversion setting information) for converting a predetermined file system into a USB file system from the user 100.

The control portion 312 stores the setting information received through the information inputting portion 311 in the information storing portion 313 to automatically set communication connection with the host computing terminal 300 by using the setting information stored in the information storing portion 313 with any subsequent reinput from the user.

Further, the control portion 312 transfers setting information corresponding to the host computing terminal 200 in the setting information received from the user through the information inputting portion 311 or the setting information stored in the information storing portion 313 to the USB/IP communication unit 320 to set communication connection with the host computing terminal 200.

Further, the control portion 312 transfers the file system conversion setting information to the file system setting portion 331 of the USB converting unit 330 to control the file converting portion 332 to convert a predetermined file system 340 into the USB storage. Herein, the predetermined file system 340 may be a file system (341, ‘an operating system supporting file system’) of a format such as FAT, EXT, NTFS, or the like supported by an operating system of the client computing terminal 300 or a file system (342, ‘an external file system’) of a device such as a memory stick, an external hard disk, or the like which be connected or disconnected by the user as desired.

The USB/IP communication unit 320 includes a communication setting portion 321, a URB processing portion 322, and a URB transmitting/receiving portion 323.

The communication setting portion 321 sets communication connection with the host computing terminal 200 by using connection setting information of the host computing terminal 200 received from the client user setting unit 310.

When the URB processing portion 322 communicates with the host computing terminal 200, the URB processing portion 322 generates a USB request block (URB) packet to be transmitted to the host computing terminal 200 and analyzes a URB packet received from the host computing terminal 200.

The URB transmitting/receiving portion 323 transmits the URB packet generated by the URB processing portion 322 to the host computing terminal 200 and receives the URB packet from the host computing terminal 200 and transfers it to the URB processing portion 322.

The USB converting unit 330 includes a file system setting portion 331 and a file converting portion 332.

The file system setting portion 331 receives the file system conversion setting information from the control portion 312 of the client user setting unit 310 and transfers it to the file converting portion 332.

The file converting portion 332 converts the predetermined file system 340 into the USB storage by using the file system conversion setting information received from the file system setting portion 331.

An operation of the present invention configured as above will be described below.

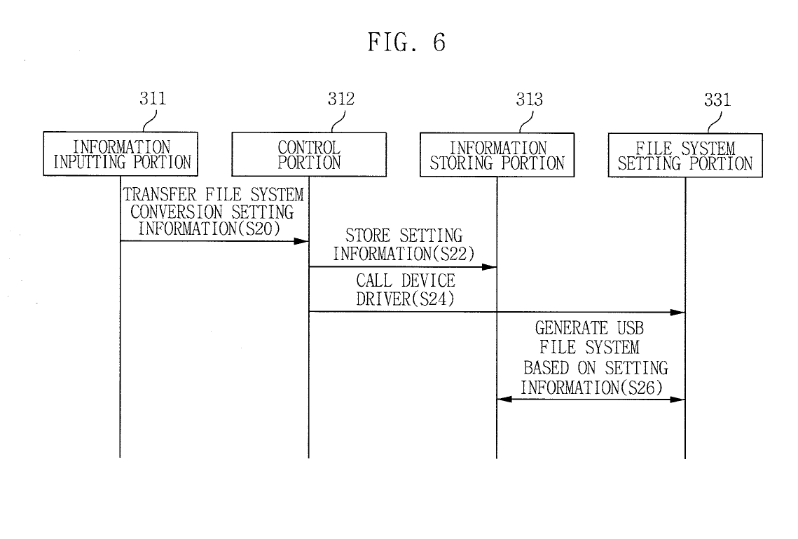

FIGS. 5 and 6 are diagrams for describing a method for making a USB storage of a file system of a client computing terminal 300 and remote connection.

First, referring to FIG. 5, when connection setting information (i.e., IP and port information of a host computing terminal) of a host computing terminal 200 is received from a user through an information inputting portion 311 of the client computing terminal 300, the information inputting portion 311 transfers the setting information to a control portion 312 (S10).

Next, the control portion 312 stores the connection setting information received from the information inputting portion 311 in an information storing portion 313 in order to reuse the connection setting information (S12) and calls a device driver of a USB/IP communication portion 320 (S14).

Then, a communication setting portion 321 of the USB/IP communication unit 320 sets communication connection with the host computing terminal 200 on the basis of the connection setting information.

Next, referring to FIG. 6, when setting information (file system conversion setting information) for converting a predetermined file system into a USB file system is received from the user through the information inputting portion 311 of the client computing terminal 300, the information inputting portion 311 transfers the setting information to the control portion 312 (S20).

Next, the control portion 312 stores the setting information received from the information inputting portion 311 in the information storing portion 313 in order to reuse the setting information and calls a device driver of a USB converting unit 330.

Then, a file system setting portion 331 of the USB file converting unit 330 generates the USB file system in a predetermined file system 340 on the basis of the file system conversion setting information.

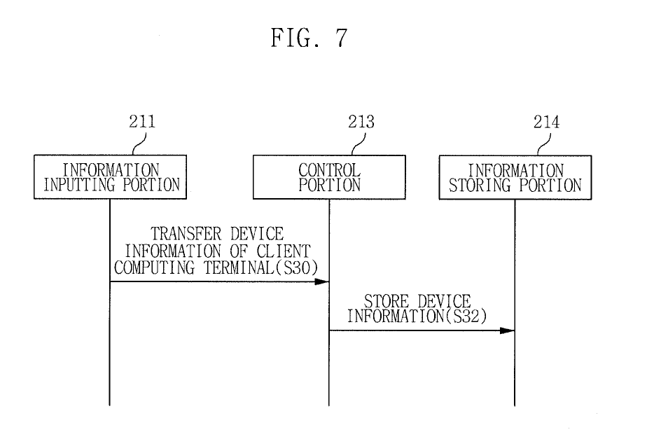

FIG. 7 is a diagram for describing a remote connection method in the host computing terminal 200.

Referring to FIG. 7, when connection setting information (i.e., IP and port information of the client computing terminal) of the client computing terminal 300 is received from the user through an information inputting portion 211 of the host computing terminal 200, the information inputting portion 211 transfers the setting information to a control portion 213.

The control portion 213 stores the setting information in an information storing portion 214. When the client computing terminal 300 is connected afterwards, the setting information is used to verify whether the client computing terminal 300 is a device registered as an available device.

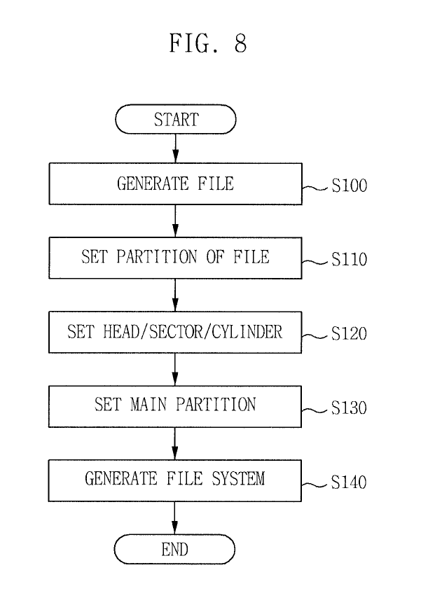

FIG. 8 illustrates a procedure of generating a USB file system to be used as a storage in the USB converting unit 330 of the client computing terminal 300.

Referring to FIG. 8, first, a file is generated (S100) and a partition of the file is set (S110). In addition, a head, a sector, and a cylinder are set (S12) and a main partition is set (S130).

Lastly, when a file system is generated (S140) and the generated file is converted into a predetermined file system and connected by a USB/IP, the file system is shown as a USB storage.

According to exemplary embodiments of the present invention, it is possible to make a USB storage of distributed file systems of a computing device owned or managed by a user to customize the distributed file systems into user's desired size and file system. In the case where the distributed file systems can be connected to each other through a network, it is possible to use the USB storage served file systems like a local USB storage without a distance limit through the network.

Some steps of the present invention can be implemented as a computer-readable code in a computer-readable recording medium. The computer-readable recording media includes all types of recording apparatuses in which data that can be read by a computer system is stored. Examples of the computer-readable recording media include a ROM, a RAM, a CD-ROM, a CD-RW, a magnetic tape, a floppy disk, an HDD, an optical disk, a magneto-optical storage device, etc., and in addition, include a recording medium implemented in the form of a carrier wave (for example, transmission through the Internet). Further, the computer-readable recording media are distributed on computer systems connected through the network, and thus the computer-readable recording media may be stored and executed as the computer-readable code by a distribution scheme.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A client computing terminal, comprising:
a client user setting unit receiving connection setting information of a host computing terminal to be communicated and file system conversion setting information for converting a predetermined file system into a USB file system from a user, and storing the corresponding information;
a USB/IP communication unit setting communication connection with the host computing terminal by using the connection setting information, generating a USB request block (URB) packet, transmitting the URB packet to the host computing terminal, and receiving and analyzing the URB packet from the host computing terminal; and
a USB converting unit converting the predetermined file system into the USB storage by using the file system conversion setting information.

2. The client computing terminal of claim 1, wherein the connection setting information includes IP and port information of the host computing terminal.

3. The client computing terminal of claim 1, wherein the predetermined file system is an operating system supporting file system supported in an operating system of the client computing terminal or an external file system which is connected or disconnected by the user.

4. The client computing terminal of claim 3, wherein the operating system supporting file system is any one of FAT, EXT, and NTFS.

5. The client computing terminal of claim 3, wherein the external file system is a memory stick or an external hard disk.

6. The client computing terminal of claim 1, wherein the client user setting unit includes a control portion setting communication connection with the host computing terminal without any subsequent reinput from the user by using the stored connection setting information.

7. The client computing terminal of claim 6, wherein the control portion transfers the stored connection setting information to the USB/IP communication unit to set communication connection with the host terminal.

8. The client computing terminal of claim 1, wherein the USB/IP communication unit includes:
a communication setting portion setting communication connection with the host computing terminal by using the connection setting information of the host computing terminal received from the client user setting unit;
a URB processing portion generating a URB packet to be transmitted to the host computing terminal and analyzing a URB packet received from the host computing terminal when communicating with the host computing terminal; and
a URB transmitting/receiving portion transmitting the URB packet generated by the URB processing portion to the host computing terminal and receiving the URB packet from the host computing terminal and transferring the received URB packet to the URB processing portion.

9. The client computing terminal of claim 1, wherein the USB converting unit includes:
a file system setting portion receiving the file system conversion setting information from the client user setting unit; and
a file converting portion converting the predetermined file system into the USB storage by using the file system conversion setting information received from the file system setting portion.

10. A host computing terminal, comprising:
a host user setting unit receiving and storing connection setting information of a client computing terminal to be communicated from a user and storing the received connection setting information, and receiving and storing information transmitted when a USB storage is set in the client computing terminal; and
a USB/IP communication unit setting communication connection with the client computing terminal by using the connection setting information, generating a USB request block (URB) packet and transmitting the generated URB packet to the client computing terminal, and receiving and analyzing the URB packet from the client computing terminal.

11. The host computing terminal of claim 10, wherein the connection setting information includes IP and port information of the client computing terminal.

12. The host computing terminal of claim 10, wherein the host user setting unit includes a control portion setting communication connection with the client computing terminal without any subsequent reinput from the user by using the stored connection setting information.

13. The host computing terminal of claim 10, further comprising:
a communication setting portion receiving information from the host user setting unit and setting communication connection with the client computing terminal on the basis of the received information;
a URB processing portion generating the USB request block (URB) packet to be transmitted to the client computing terminal and analyzing the URB packet received from the client computing terminal; and
a URB transmitting/receiving portion transmitting the URB packet generated by the URB processing portion to the client computing terminal and receiving the URB packet from the client computing terminal and transferring the received URB packet to the URB processing portion.

14. A method for making a USB storage of a file system and remote connection, the method comprising:
receiving, by a client computing terminal, connection setting information of a host computing terminal and file system conversion setting information for converting a predetermined file system into a USB file system from a user and storing the corresponding information;
setting communication connection with the host computing terminal on the basis of the connection setting information of the host computing terminal; and
generating the USB file system in the predetermined file system on the basis of the file system conversion setting information.

15. The method of claim 14, further comprising generating a USB request block (URB) packet and transmitting the generated URB packet to the host computing terminal and receiving the URB packet from the host computing terminal and analyzing the received URB packet.

16. The method of claim 14, wherein the connection setting information includes IP and port information of the host computing terminal.

17. The method of claim 14, wherein the predetermined file system is an operating system supporting file system supported in an operating system of the client computing terminal or an external file system which is connected or disconnected by the user.

18. The method of claim 17, wherein the operating system supporting file system is any one of FAT, EXT, and NTFS.

19. The method of claim 17, wherein the external file system is a memory stick or an external hard disk.

20. The method of claim 14, further comprising setting communication connection with the host computing terminal without any subsequent reinput from the user by using the stored connection setting information.
